(19) United States
(12) Patent Application Publication
(10) Pub. No.: US 2018/0133887 A1
(43) Pub. Date: May 17, 2018

(54) SHOCK-ABSORBING TOOL HANDLE

(71) Applicant: AJC Tools & Equipment, Hudson, OH (US)

(72) Inventor: Matthew J. Crookston, Stow, OH (US)

(21) Appl. No.: 15/808,139

(22) Filed: Nov. 9, 2017

Related U.S. Application Data
(60) Provisional application No. 62/421,574, filed on Nov. 14, 2016.

(51) Int. Cl. B25G 1/01

(52) U.S. Cl. CPC B25G 1/01; A01B 1/227

(57) ABSTRACT

An apparatus comprising a hand tool handle and an implement adapted for use with an associated workpiece is provided. A method of using a hand tool is also provided, the method comprises applying a force to the hand tool and contacting a workpiece with an implement thereof.

### CROSS REFERENCE TO RELATED APPLICATIONS

This application claims priority from U.S. Provisional Patent Application No. 62/421,574 which was filed on Nov. 14, 2016.

### FIELD OF THE INVENTION

This invention relates to a shock-absorbing handle for a tool, and in particular a shock-absorbing handle for hand tools such as shingle removal tools, spades, shovels, pitch forks and the like.

### BACKGROUND AND SUMMARY

The use of hand tools dates to the stone age, when humans first used stones for hammering and cutting. In time, both the materials and design of hand tools have evolved to provide users with greater comfort and more effective operation. These improvements have included modifications to the hand tool's working end and handle.

The working end may be broadly understood to include the distal portion of the hand tool that has an implement attached for contact with a workpiece. The implement is designed to provide the desired effect when it comes into contact with the workpiece; one non-limiting example would be a spade head (implement) that is adapted to easily remove soil from the ground (workpiece). The implement is also adapted to attach to the handle, which is designed to assist the user in holding and manipulating the working end of the hand tool; one non-limiting example of a handle includes a shaft and a grip that is proximal to, and engaged by, the user.

The evolution of hand tools has included numerous changes to the handle that provide for easy replacement, reduced weight, and improved ergonomics. To date, however, efforts to modify hand tool handles to minimize the impact stresses users feel when working with hand tools that strike, or are driven into, a workpiece have been largely unsuccessful. For example, the addition of a padded portion to the handle grip has been insufficient to reduce impact stresses passed along to the user during operation. Design changes to hand tool handles that permit movement of the working end relative to the handle have also been ineffective, as the torsional forces generated during use cause unacceptable torsional movement of the implement.

The general object of the present invention is to provide a new and improved handle for a hand tool, wherein the handle is characterized by shock-absorbing qualities that minimize impact stresses generated during use. It is also an object to provide a shock-absorbing hand tool handle that is highly resistant to torsional forces and can maintain proper position of the implement during use.

Particular embodiments of the present invention include an apparatus comprising a hand tool handle and an implement adapted for use with an associated workpiece, wherein the hand tool handle comprises a shock-absorbing assembly for absorbing impact forces and resisting torsional movement caused by the implement's contact with the associated workpiece.

Embodiments of the present invention also include a method of using a hand tool comprising applying a force to the hand tool, the hand tool comprising a hand tool handle and an implement. The implement is arranged at a distal end of the hand tool, and the hand tool handle comprises a shock-absorbing assembly. The method further includes contacting workpiece with the implement, wherein the shock-absorbing assembly absorbs impact forces and resists torsional movement caused by the implement's contact with the workpiece.

These and other features and advantages of the present invention will be apparent to those of skill in the art in view of the following written description and drawings.

### BRIEF DESCRIPTION OF THE DRAWINGS

FIG. 1 shows an exploded perspective view of an example of a hand tool handle in accordance with the present invention.

FIG. 2A shows a perspective view of an example of a hand tool handle in accordance with the present invention.

FIG. 2B shows an exploded perspective view of an example of a hand tool handle, and associated working end implement, in accordance with the present invention.

FIGS. 3-5 show some example implements, in accordance with the present invention.

FIG. 6 shows a disassembled partial perspective view of an example of a hand tool handle, and associated working end implement, in accordance with the present invention.

FIG. 7 shows an assembled partial top end perspective view of an example of a hand tool handle, and associated working end implement, in accordance with the present invention.

FIG. 8 shows another assembled partial top view of an example of a hand tool handle, and associated working end implement, in accordance with the present invention.

FIG. 9 shows an assembled partial bottom perspective view of an example of a hand tool handle, and associated working end implement, in accordance with the present invention.

### DETAILED DESCRIPTION

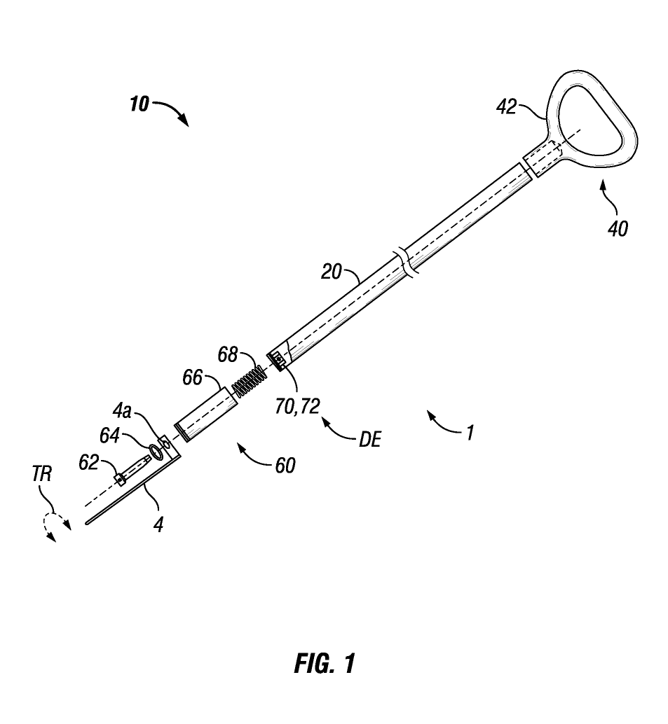

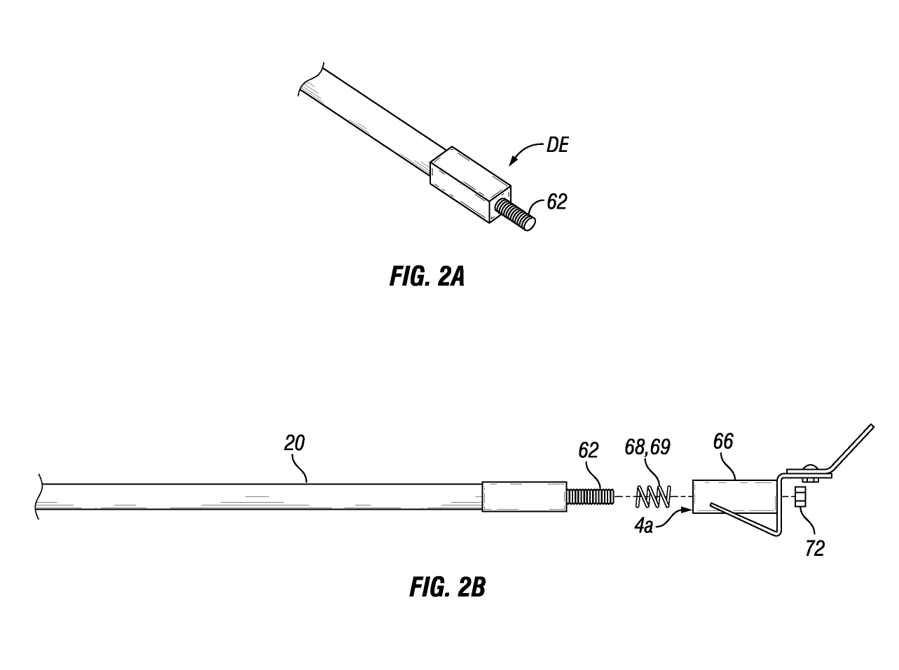

An example of a shock-absorbing hand tool 1 in accordance with one embodiment of the present invention is shown in FIGS. 1, 2A, and 2B. Greatly simplified, the shock-absorbing hand tool 1 of the present invention may include a working end and a handle 10.

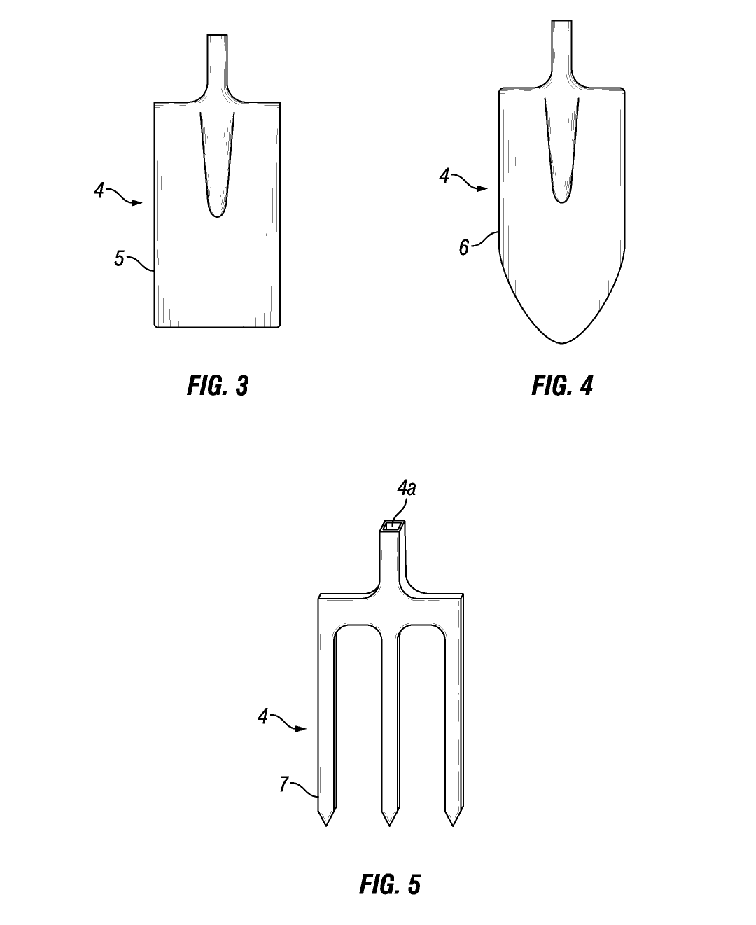

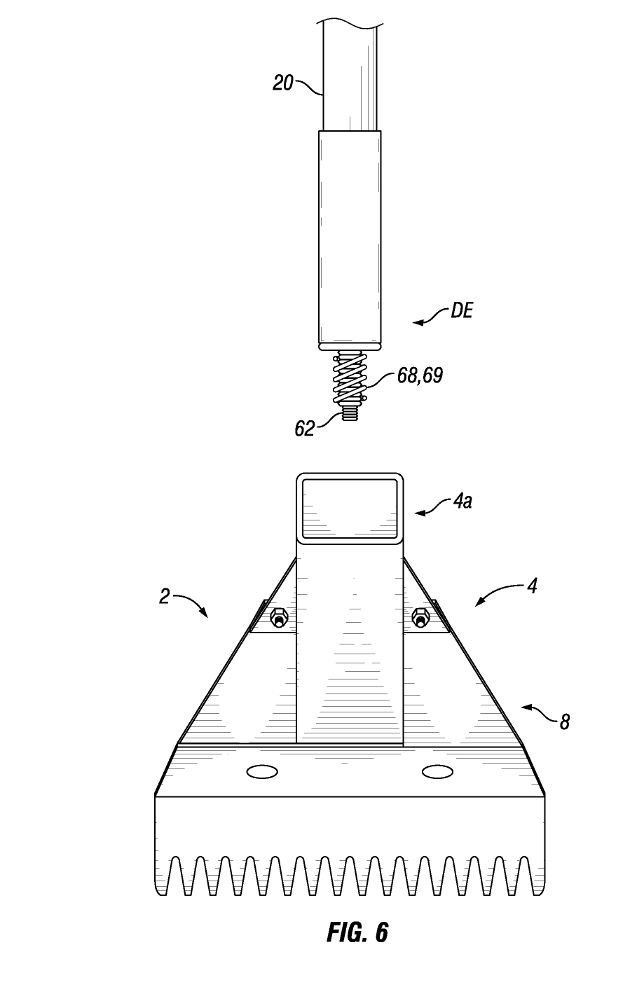

The working end is situated at the end distal to the user's hands and includes one or more implements 4 that are configured to effect a change to an associated workpiece. By way of non-limiting examples, with reference to FIGS. 3-6, the implement 4 may be a component commonly recognized as being associated with the working end (head) of a garden tool, such as a spade 5, shovel 6, pitch fork 7 or the like. In other embodiments, the implement 4 may be a shingle removal tool 8, or other striking tool as is known in the art, where a reduction in the impact forces transmitted to the user during operation may be desired to be reduced.

The hand tool handle 10 may include a shaft 20, a grip 40 and a shock-absorbing assembly 60. The grip 40 may be situated at the end proximal to the user's hands, and adapted to facilitate handling and use of the hand tool 1, and may be configured in any shape or size chosen with sound engineering judgment, including particularly the form of a D-grip 42. The grip 40 may be adapted for operative attachment to the shaft 20. The shaft 20, which can be a solid or hollow elongated member, may be adapted to operatively engage the grip 40 at the end proximal to the user, and the shock-absorbing assembly 60, and/or implement 4, at the end distal to the user. The shaft 20 can be substantially straight, curved, or consisting of various angles in its lengthwise direction, and consist of a cross-sectional shape that is partially, or entirely, round, oval, square, rectangular or the like. In some embodiments, the shaft 20 may comprise one or more sections such that one of the one or more sections telescopes into another of the one or more sections.

With reference to FIG. 1, the shock-absorbing assembly 60 may comprise one or more of a bolt 62, washer 64, housing 66, compression device 68, and attachment means 70. The bolt 62 may be adapted to operatively engage, and secure, the implement 4 to the shaft 20. For example, in the embodiment shown in FIG. 1, the implement 4 is secured to the shaft 20 after the bolt 62 passes through the washer 64, an aperture 4a in the implement 4, the housing 66, the compression device 68 and is mated with the attachment means 70. In the embodiment shown in FIG. 1, the attachment means 70 is a nut 72 which is adapted to selectively mate with the bolt 62. In some embodiments, the nut 72 is welded to the shaft 20, for example, in one version, to an interior surface of a hollow shaft 20.

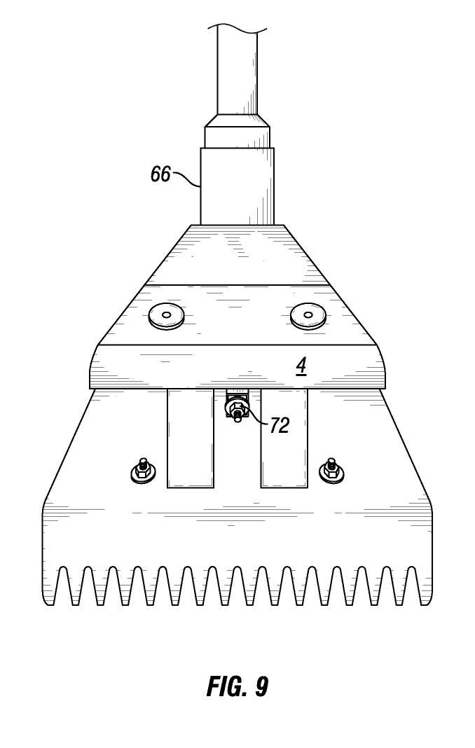

In still other embodiments, shown in FIGS. 2A, 2B, and 6-9, the bolt 62 is seated within the shaft 20, and secures the implement 4 by passing through the compression device 68, a housing 66, an aperture 4a in the implement 4, and one or more of a washer 64 and nut 72. The bolt 62 may be welded into the shaft 20, or it may only be secured to the interior of the shaft upon engagement with the nut 72.

In one embodiment, the compression device 68 is a spring 69, such as a die spring, a heavy spring, or other spring selected by a person of skill in the art The spring 69 may have a diameter which permits the bolt 62 to pass through the spring 69 before mating with the nut 72. In other embodiments, the compression device 68 may be a hydraulic, pneumatic, gas shock, or coilover type shock absorber.

In these configurations, when the implement 4 is assembled onto the shock-absorbing assembly 60 and shaft 20 it is situated in a resting position RP, until impact forces F caused by impact of the implement 4 onto the workpiece cause the implement 4 to travel temporarily into a working position WP, defined generally as a position that is more proximal to the user than when the implement 4 is in a resting position RP, by virtue of movement of the compression device 68. The travel of the implement 4 relative to the handle 10—from a resting position RP to the working position WP, and back to the resting position RP as impact forces are absorbed—dampens the impact forces that would otherwise be transmitted to the user, thereby permitting the user to manipulate the hand tool 1 with greater comfort.

In various embodiments of the invention the distance the implement 4 travels from the resting position RP to the working position WP can vary according to user preferences. In one embodiment, the implement 4 travels approximately one quarter (¼) of an inch between its resting position RP and working position WP. In other embodiments, which might be characterized as further softening impact forces, the implement 4 moves approximately one (1) inch between its resting position RP and working position WP. In still other embodiments, the implement 4 may travel between one quarter (¼) inch and one (1) inch, or between one (1) inch and two (2) inches, or greater than two (2) inches between the resting position RP and working position WP.

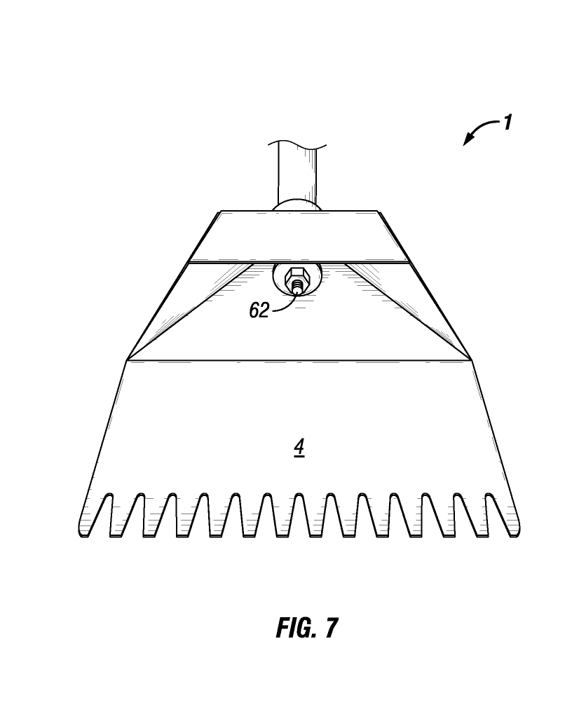

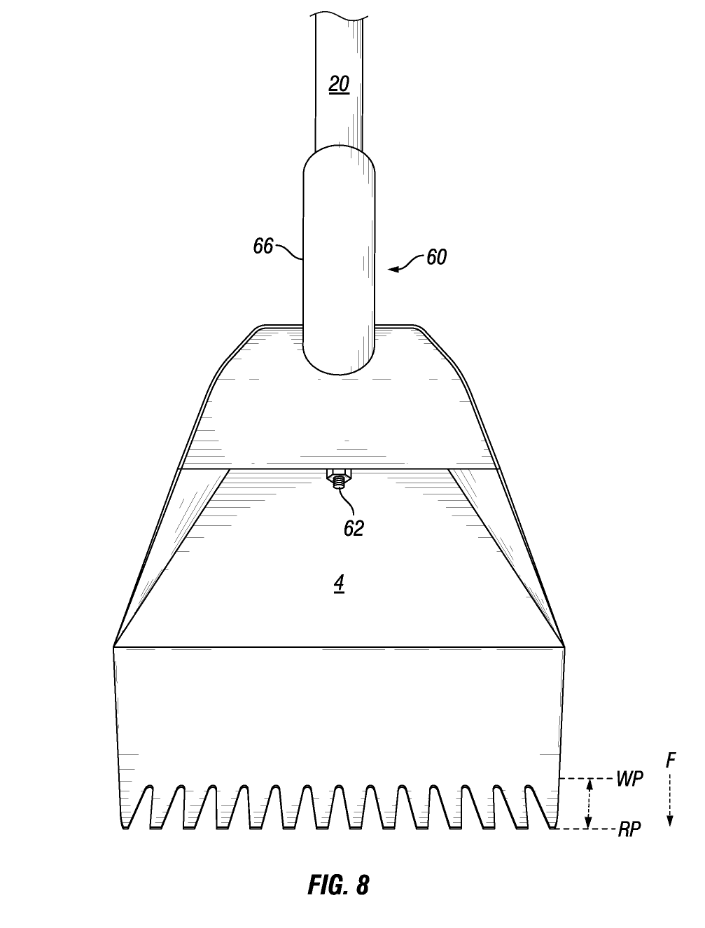

In embodiments of the invention the distance the implement 4 is configured to travel between a resting position RP and working position WP can be changed by adjusting the position of the nut 72 relative to the bolt 62. For example, tightening the bolt 62 into the nut 72 secured within the shaft 20 compresses the spring 68 to a point where the implement 4 travels less distance between its resting position RP and its working position WP when confronted with impact forces. Similarly, as shown in FIGS. 7 and 8, in other embodiments the bolt 62 may be secured into the shaft 20, and compression of the spring 68—which, in turn, shortens the distance the implement 4 travels between a resting position RP and working position WP—occurs when the nut 72 is tightened onto the bolt 62. Conversely, as the bolt 62 and nut 72 is loosened, compression of the spring 68 is reduced, thereby permitting the implement 4 to travel a greater distance between the resting position RP and working position WP.

It may also be a feature of the invention that the implement 4 is resistant to the torsional forces caused by impact with the workpiece. In short, unless the shock-absorbing assembly 60 is configured to move the implement 4 between the resting position RP and working position WP in a substantially reciprocating path along the longitudinal axis of the handle 10, then torsional rotation TR of the implement 4 relative to the shaft 20 can cause either damage or ineffective and imprecise operation of the hand tool 1.

To prevent unwanted torsional movement, in some embodiments the shaft 20 has a distal end DE with a shape corresponding to the housing 66 of the shock-absorbing assembly 60. In some embodiments, the housing 66 is fixedly engaged to the implement 4. In the embodiment shown in FIGS. 2A and 2B, for example, the shaft 20 has a substantially square distal end DE that is adapted to be received within a substantially square housing 66; in this configuration, torsional rotation of the implement 4 during travel between the resting position RP and working position WP is prevented. In other embodiments, the shaft 20 has a substantially oval shaped distal end DE that is adapted to be received within a substantially oval shaped housing 66 and prevents torsional movement of the implement 4. On other versions, the distal end DE and housing may be of any other shape, such as rectangular, triangular, pentagonal, hexagonal, trapezoidal, or the like, which might be configured to prevent torsional movement of the implement 4 relative to the shaft 20. In one version, the distal end DE may have a protuberance, such as a boss, that is adapted to reciprocate within an associated groove in the housing 66, as the implement 4 travels between the resting position RP and working position WP.

In some embodiments, the distal end DE of the shaft is of a shape different than the rest of the shaft 20; by way of non-limiting example, shown in FIGS. 2A and 2B, the shaft 20 may be substantially round, for ergonomic user comfort, but have a distal end DE that is square shaped. In various versions, the housing 66 may be a standalone component of the shock-absorbing assembly 60, as shown in FIG. 1, or integral to the implement 4, as shown in FIG. 2B. In embodiments, the shaft 20 may be a unitary piece which a distal end DE being a portion that is machined to provide a shape different from the rest of the shaft, while in others the distal end DE is a component operatively attached to the shaft 20.

It should be recognized that the present invention is not limited to the exemplary hand tool handle 10 as shown. The configuration described herein and the particulars thereof can be readily applied to a variety of tools and applications. It is therefore understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. An apparatus comprising:
a hand tool handle; and
an implement adapted for use with an associated workpiece,
wherein the hand tool handle comprises a shock-absorbing assembly for absorbing impact forces and resisting torsional movement caused by the implement's contact with the associated workpiece.

2. The apparatus of claim 1, wherein:
the shock-absorbing assembly comprises a bolt, a nut, a compression device, and a housing, and
the hand tool handle comprises a shaft, wherein the shaft has a distal end with a shape that corresponds with the shape of the housing.

3. The apparatus of claim 2, wherein the shock-absorbing assembly is configured to permit between approximately one quarter inch and one half inch of travel between the implement and the shaft upon a force being applied to the hand tool handle.

4. The apparatus of claim 3, wherein the shock-absorbing assembly is configured to permit one quarter inch of travel between the implement and the shaft upon a force being applied to the hand tool handle.

5. The apparatus of claim 2, wherein the shaft has a distal end with a shape that is different than a shape of the shaft.

6. The apparatus of claim 2, wherein the nut is welded to the shaft.

7. The apparatus of claim 6, wherein the shaft is hollow and the nut is welded into an interior surface of the shaft.

8. The apparatus of claim 5, wherein the distal end of the shaft is hollow.

9. The apparatus of claim 5, wherein a cross-sectional shape of the distal end is oval.

10. The apparatus of claim 5, wherein a cross-sectional shape of the distal end is square.

11. The apparatus of claim 2, wherein the compression device is a heavy spring.

12. The apparatus of claim 2, wherein the compression device is selected from the group consisting of a hydraulic, pneumatic, gas shock, or coilover shock absorber.

13. The apparatus of claim 2, wherein the shock-absorbing assembly moves the implement between a resting position and a working position in a substantially reciprocating path along a longitudinal axis of the handle.

14. A method of using a hand tool, the method comprising:
applying a force to the hand tool, the hand tool comprising:
a hand tool handle; and
an implement, the implement being arranged at a distal end of the hand tool,
wherein the hand tool handle comprises a shock-absorbing assembly;
contacting a workpiece with the implement, wherein the shock-absorbing assembly absorbs impact forces and resists torsional movement caused by the implement's contact with the workpiece.

15. The method of claim 14, wherein the shock-absorbing assembly moves the implement between a resting position and a working position in a substantially reciprocating path along a longitudinal axis of the handle.
